(19) United States
(12) Patent Application Publication
(10) Pub. No.: US 2012/0125535 A1
(43) Pub. Date: May 24, 2012

(54) THIN FILM DRYING METHOD AND ALIGNMENT FILM DRYING METHOD AND METHOD FOR MANUFACTURING DISPLAY PANEL

(75) Inventors: Chengming He, Shenzhen (CN); Xingke Zheng, Shenzhen (CN); Hsiang-yin Shih, Shenzhen (CN); Wei-chun Lee, Shenzhen (CN); Bing-jei Liao, Shenzhen (CN)

(73) Assignee: SHENZHEN CHINA STAR OPTOELECTRONICS TECHNOLOGY CO., LTD., Shenzhen (CN)

(21) Appl. No.: 13/217,600

(22) Filed: Aug. 25, 2011

(30) Foreign Application Priority Data
Nov. 18, 2010 (CN) 201010553829.6

(51) Int. Cl. F26B 5/04; B29C 65/48

(52) U.S. Cl. 156/285; 34/406; 34/412

(57) ABSTRACT

The present invention provides a thin film drying method, an alignment film drying method and a method for manufacturing a display panel. The thin film drying method comprises the following steps: forming the thin film on a substrate; placing the substrate in a vacuum chamber; and reducing a pressure in the vacuum chamber. The thin film drying method can be applicable to the alignment film drying method and the method for manufacturing the display panel. The invention can enhance the film quality after drying.

### FIELD OF THE INVENTION

The present invention relates to a thin film drying method, and more particularly to an alignment film drying method and a method for manufacturing a display panel.

### BACKGROUND OF THE INVENTION

Liquid crystal displays (LCDs) have been widely applied in electrical products. Currently, most of LCDs are backlight type LCDs which comprise a liquid crystal panel and a backlight module. The liquid crystal display panel is composed of two transparent substrates and a liquid crystal sealed there-between.

In the process for manufacturing the liquid crystal display panel, it is necessary to manufacture an alignment film for determining the orientation of the liquid crystal. In general, the material of the alignment film is a liquid polyimide (PI) which is formed on the substrate of the liquid crystal display panel by coating. Subsequently, the alignment film needs to be heated, so as to evaporate a liquid solvent in the PI, thereby forming a solid alignment film.

In a general process for heating the alignment film, the substrate with the coated alignment film is placed above a heating plate for heating by using supporting pins which are disposed on the heating plate. The temperature uniformity of the heating and a drying speed are important factors affecting the alignment film. However, in this heating process, the temperature is non-uniform at the positions where the supporting pins contact with the substrate, i.e. the temperature at the positions of the substrate contacting with the supporting pins is different to the temperature at the other positions thereof. Therefore, a non-uniform drying speed of the alignment film coated on the substrate occurs, thus significantly deteriorating the film quality of the alignment film.

As a result, it is necessary to provide a thin film drying method, an alignment film drying method and a method for manufacturing a display panel to solve the problems existing in the conventional technologies, as described above.

### SUMMARY OF THE INVENTION

A primary object of the present invention is to provide a drying method of a thin film comprising a liquid solvent, and the method comprises the following steps: forming the thin film on a substrate; placing the substrate in a vacuum chamber; and reducing a pressure in the vacuum chamber, so as to allow the liquid solvent of the thin film in the vacuum chamber to vaporize.

Another object of the present invention is to provide a drying method of an alignment film comprising a liquid solvent, and the method comprises the following steps: forming the alignment film on a substrate; placing the substrate in a vacuum chamber; and reducing a pressure in the vacuum chamber, so as to allow the liquid solvent of the alignment film in the vacuum chamber to vaporize.

A further object of the present invention is to provide a method for manufacturing a display apparatus, the method comprises the following steps: forming a first alignment film on a first substrate, wherein the first alignment film comprises a liquid solvent; forming a second alignment film on a second substrate, wherein the second alignment film comprises the liquid solvent; placing the first substrate and/or the second substrate in a vacuum chamber; and reducing a pressure in the vacuum chamber down to a predetermined vacuum pressure, so as to allow the liquid solvent of the first alignment film and/or the second alignment film in the vacuum chamber to vaporize; and after the liquid solvent vaporized, forming a liquid crystal layer between the first alignment film and the second alignment film.

In one embodiment of the present invention, the pressure in the vacuum chamber is reduced down to a predetermined vacuum pressure, so as to allow the liquid solvent of the film in the vacuum chamber to vaporize.

In one embodiment of the present invention, the predetermined vacuum pressure is larger than or equal to 13 Pa and less than or equal to 53 Pa.

In one embodiment of the present invention, the predetermined vacuum pressure is larger than or equal to 26 Pa and less than or equal to 53 Pa.

In one embodiment of the present invention, a temperature in the vacuum chamber is larger than or equal to 22° C. and less than or equal to 27° C.

In one embodiment of the present invention, the method further comprises the following step: after the liquid solvent vaporized for a predetermined time, heating the alignment film under a normal pressure wherein a temperature for heating is larger than or equal to 80° C. and less than or equal to 100° C.

In one embodiment of the present invention, after heating the alignment films, implementing a high-temperature heating to the alignment films, wherein temperature of the high-temperature heating is larger than or equal to 220° C. and less than or equal to 230° C.

The thin film drying method, the alignment film drying method and the method for manufacturing the display panel of the present invention can dry the thin film under the normal temperature condition with heating, so as to dry the thin film under a uniform temperature (normal temperature) condition for enhancing the film quality after drying.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a cross-sectional view showing a display panel and a backlight module according to an embodiment of the present invention;

FIG. 2 is a flow diagram showing a method for manufacturing the display panel according to an embodiment of the present invention;

FIG. 3 is a schematic diagram showing the substrate placed in a vacuum chamber according to an embodiment of the present invention; and

FIG. 4 is a schematic diagram showing the substrate placed on a heating plate according to an embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

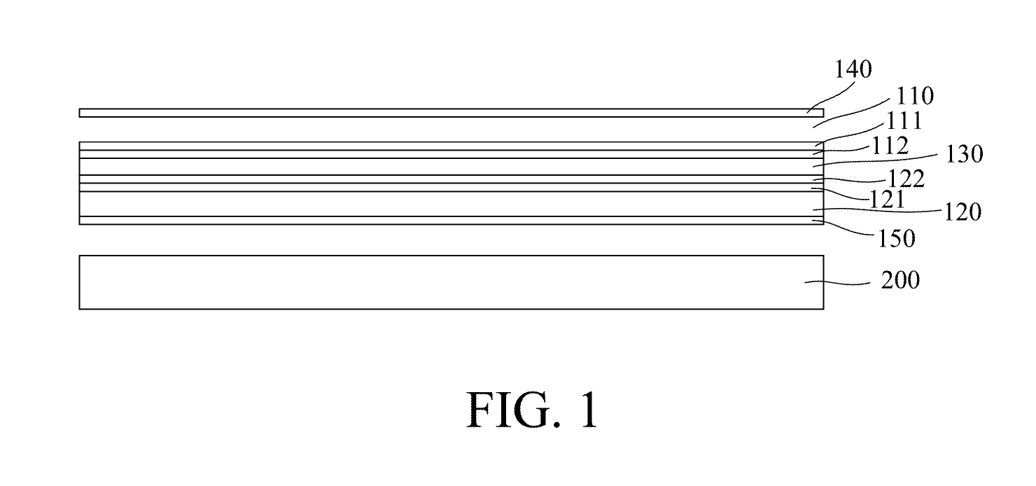

Referring to FIG. 1, a cross-sectional view showing a display panel and a backlight module according to an embodiment of the present invention is illustrated. The thin film drying method can be applied to the fabrication of the liquid crystal display panel 100 for drying alignment films (thin films) 112, 122 of the liquid crystal display panel 100. When utilizing the display panel 100 of the present embodiment to fabricate a display apparatus, the display panel 100 may be disposed on the backlight module 200, thereby forming a liquid crystal display apparatus. The display panel 100 may comprise a first substrate 110, a second substrate 120, a liquid crystal layer 130, a first polarizer 140 and a second polarizer 150. The first substrate 110 and the second substrate 120 may be realized as glass substrates or flexible plastic substrates. In this embodiment, the first substrate 110 may be a glass substrate or other material substrate with color filters (CF), and the second substrate 120 may be a glass substrate or other material substrate with a thin film transistor (TFT) array. It notes that the CF and the TFT array may also be disposed on the same substrate in other embodiments.

Referring to FIG. 1 again, the liquid crystal layer 130 is formed between the first substrate 110 and the second substrate 120. The first polarizer 140 is disposed on one side of the first substrate 110 and opposite to the liquid crystal layer 130 (as a light-emitting side). The second polarizer 150 is disposed on one side of the second substrate 120 and opposite to the liquid crystal layer 130 (as a light-incident side).

Referring to FIG. 1 again, in this embodiment, the first substrate 110 may comprise a first electrode 111 and a first alignment film 112, and the second substrate 120 may comprise a second electrode 121 and a second alignment film 122. The first electrode 111 and the second electrode 121 are preferably made of a transparent and electrically conductive material, such as ITO, IZO, AZO, GZO, TCO or ZnO. A voltage can be applied to the liquid crystal molecules 102 of the liquid crystal layer 130 by the first electrode 111 and the second electrode 121. In this embodiment, the first electrode 111 may be a common electrode, and the second electrode 121 may be a pixel electrode.

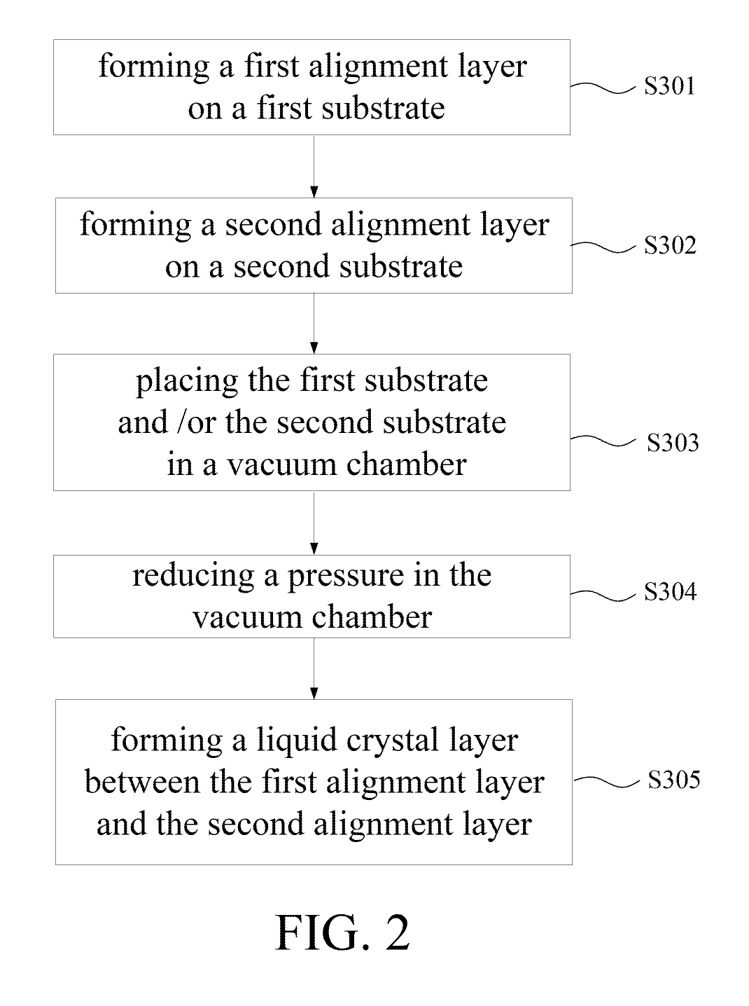

Referring to FIG. 2, a flow diagram showing a method for manufacturing the display panel according to an embodiment of the present invention is illustrated. When implementing the manufacturing method of the display panel of the present embodiment, firstly, the first alignment film 112 is formed on the first substrate 110 (step S301), and the second alignment film 122 is formed on the second substrate 120 (step S302). Before the steps S301 and S302, the first electrode 111 is formed on the first substrate 110, and the second electrode 121 is formed on the second substrate 120. Furthermore, before the steps S301 and S302, the substrates 110, 120 having the electrodes 111, 121 may be pre-cleaned and pre-cured, so as to clean the surfaces of the substrates 110, 120 (i.e. the surfaces of the electrodes 111, 121). In the steps S301 and S302, the material of the first alignment film 112 and the second alignment film 122 may be a polyimide (PI). The liquid polyimide can be coated on the electrodes 111, 121 of the substrates 110, 120, so as to form the first alignment film 112 and the second alignment film 122, respectively. At this time, before drying, the first alignment film 112 and the second alignment film 122 comprise a liquid solvent which may be for example butyl cellosolve (BC) and/or N-methyl-2-pyrrolidone (NMP).

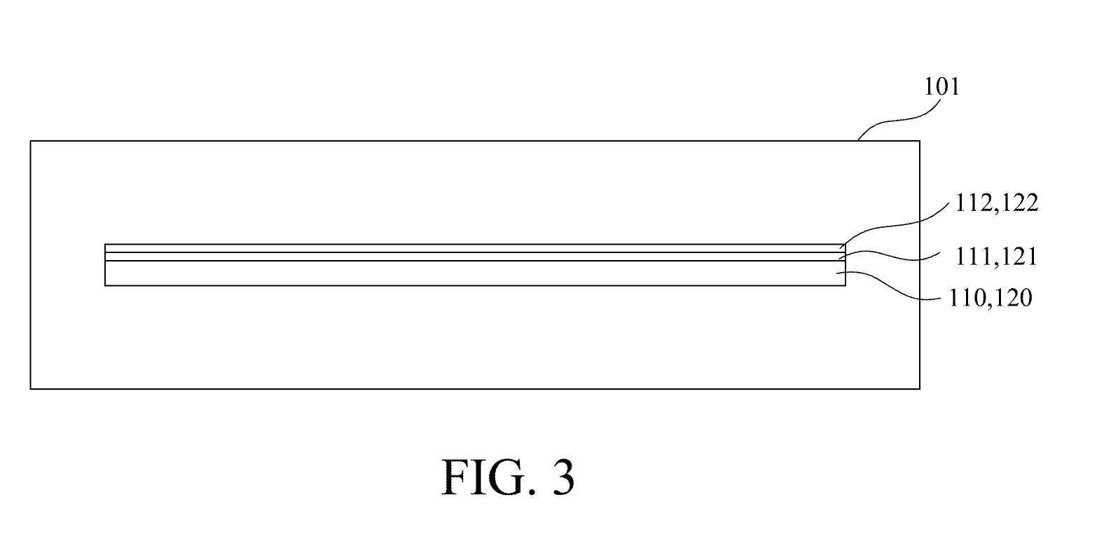

Referring to FIG. 2 and FIG. 3, FIG. 3 is a schematic diagram showing the substrate placed in a vacuum chamber according to an embodiment of the present invention. Subsequently, the first substrate 110 and/or the second substrate 120 can be placed in the vacuum chamber 101 (step S303) for drying the alignment films 112, 122 of the substrates 110, 120. At this time, the first substrate 110 and the second substrate 120 may be placed in the vacuum chamber 101 at the same time for drying. Alternatively, the first substrate 110 and the second substrate 120 may be placed separately in the vacuum chamber 101 at the same time for drying.

Referring to FIG. 2 and FIG. 3 again, subsequently, the pressure in the vacuum chamber 101 is reduced (step S304) to allow the liquid solvent of the first alignment film 112 and/or the second alignment film 122 to vaporize, so as to dry the alignment films 112, 122. The gas in the vacuum chamber 101 can be pumped to the outside thereof by a pumping device (such as a pump) for reducing the pressure in the vacuum chamber 101. At the same time, with the pumping of the vacuum chamber 101, the residual gas on the substrates 110 and/or 120 can be exhausted, thereby reducing the bubble defects and enhancing the film quality of the substrates 110, 120. A vaporization temperature of a liquid is proportional to an environmental pressure. Therefore, when the pressure (the environmental pressure) in the vacuum chamber 101 is reduced, the vaporization temperature of the first alignment film 112 and/or the second alignment film 122 in the vacuum chamber 101 is also reduced. In this embodiment, the pressure in the vacuum chamber 101 is reduced down to a predetermined vacuum pressure, so as to allow the liquid solvent of the alignment films 112, 122 to vaporize under a normal temperature (or a room temperature) condition (such as 22˜35° C.), thereby evaporating the liquid solvent of the alignment films 112, 122 to achieve the drying effect thereof. Therefore, the liquid solvent of the alignment films 112, 122 can vaporize under the normal temperature condition without heating. Since the liquid solvent of the alignment films 112, 122 can vaporize under the normal temperature condition without heating, i.e. the alignment films 112, 122 can be dried under a uniform temperature (the normal temperature) condition, the alignment films 112, 122 can have a consistent drying speed to improve the problem of non-uniform heating temperature in the conventional drying method, and to enhance the film quality of the alignment films.

When the liquid solvent of the alignment films 112, 122 in the vacuum chamber 101 vaporize under the normal temperature condition, the pressure therein is the predetermined vacuum pressure, such as larger than or equal to 13 Pa and less than or equal to 53 Pa. The predetermined vacuum pressure can be determined according to the composition of the liquid solvent of the alignment films 112, 122 and the normal temperature condition (the current environmental temperature). For example, in this embodiment, the composition of the liquid solvent of the alignment films 112, 122 may be BC or NMP, wherein the content of the BC is 51%, and the content of the NMP is 45%, and the vapor pressure of the BC is 266 Pa, and vapor pressure of the NMP is 53 Pa. At this time, the predetermined vacuum pressure may be larger than or equal to 26 Pa and less than or equal to 53 Pa, so as to allow the liquid solvent of the alignment films 112, 122 to vaporize under the normal temperature condition of the temperature which is larger than or equal to 22° C. and less than or equal to 27° C.

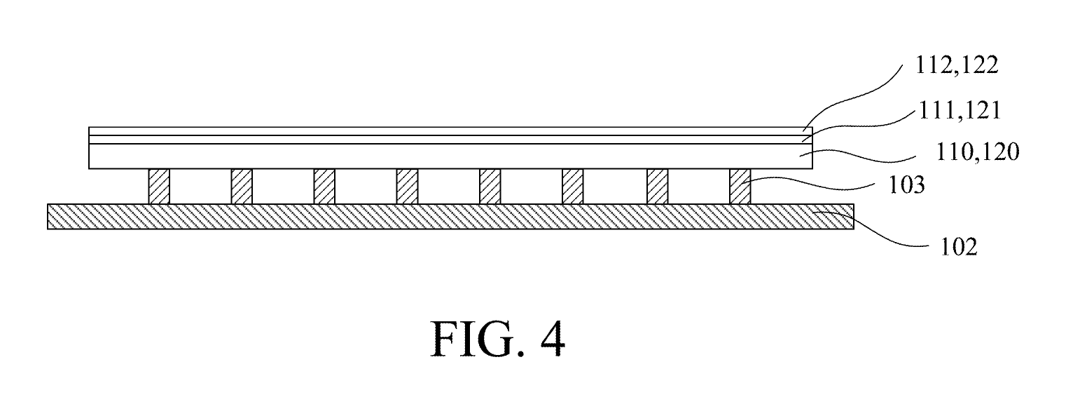

Referring to FIG. 4, a schematic diagram showing the substrate placed on a heating plate according to an embodiment of the present invention. In one embodiment, after the vacuum drying step (the step S304), and after the liquid solvent in the vacuum chamber 101 vaporized for a predetermined time, the alignment films 112 and/or 122 on the substrates 110 and/or 120 may be heated under a normal pressure to ensure that the liquid solvent of the alignment films 112, 122 vaporizes completely, thereby achieving a complete drying effect. At this time, the alignment films 112 and/or 122 may be heated by the heating plate 102, wherein the substrates 110 and/or 120 may be placed above supporting pins 103 of the heating plate 102, and the heating temperature may be larger than or equal to 80° C. and less than or equal to 100° C. Subsequently, a high-temperature heating is implemented again under the normal pressure, so as to ensure that the liquid solvent of the alignment films 112, 122 vaporizes completely. The temperature of the high-temperature heating may be larger than or equal to 220° C. and less than or equal to 230° C.

Referring to FIG. 1 and FIG. 2 again, after drying the alignment films 112, 122, subsequently, the liquid crystal layer 130 is formed between the first alignment film 112 of the first substrate 110 and the second alignment film 122 of the second substrate 120 (step S305), thereby forming the liquid crystal panel. In this embodiment, the liquid crystal of the liquid crystal layer 130 may be first dispensed within the sealant (not shown) on the first substrate using, for example, a one-drop filling (ODF) method, and then the second substrate 120 can be aligned and assembled with the first substrate 110 using an alignment assembly apparatus, and the sealant is cured, thereby forming the liquid crystal layer 130 between the first substrate 110 and the second substrate 120.

Therefore, the thin film drying method of the present invention can be applied to the fabrication of the liquid crystal display panel 100 for drying the alignment films 112, 122. When implementing the drying method of the thin film, the thin film can be formed on the substrate (such as the first substrate 110 and/or the second substrate 120). Subsequently, the substrate with the thin film waited for drying is placed in the vacuum chamber 101. Subsequently, the pressure in the vacuum chamber 101 is reduced down to the predetermined vacuum pressure, so as to allow the liquid solvent of the thin film in the vacuum chamber 101 to vaporize for drying it. However, the thin film drying method may also be applied to dry other thin films but not limited to the above description.

As described above, the thin film drying method, the alignment film drying method and the method for manufacturing the display apparatus of the present invention can dry the thin film under the normal temperature condition without heating, thereby preventing the problem of non-uniform heating temperature. Therefore, with the drying method of the present invention, the thin film (such as the alignment films) can have great film quality after drying. For example, the thin film can have a uniform thickness. Furthermore, in the vacuum drying process, the residual bubble on the substrate can be removed, thereby enhancing the quality of the film on the substrate.

The present invention has been described with a preferred embodiment thereof and it is understood that many changes and modifications to the described embodiment can be carried out without departing from the scope and the spirit of the invention that is intended to be limited only by the appended claims.

1. A drying method of a thin film comprising a liquid solvent, characterized in that: the method comprises the following steps:
forming the thin film on a substrate;
placing the substrate in a vacuum chamber, wherein a temperature in the vacuum chamber is larger than or equal to 22° C. and less than or equal to 27° C.; and
reducing a pressure in the vacuum chamber down to a predetermined vacuum pressure, so as to allow the liquid solvent of the thin film in the vacuum chamber to vaporize, wherein the predetermined vacuum pressure is larger than or equal to 13 Pa and less than or equal to 53 Pa.

2. The method according to claim 1, characterized in that: the predetermined vacuum pressure is larger than or equal to 26 Pa and less than or equal to 53 Pa.

3. The method according to claim 1, characterized in that: the method further comprises the following step: after the liquid solvent vaporized for a predetermined time, heating the thin film under a normal pressure.

4. The method according to claim 3, characterized in that: in the heating process, a temperature for heating is larger than or equal to 80° C. and less than or equal to 100° C.

5. The method according to claim 4, characterized in that: the method further comprises the following step: after heating the thin film, implementing a high-temperature heating to the thin film, wherein temperature of the high-temperature heating is larger than or equal to 220° C. and less than or equal to 230° C.

6. A method for manufacturing the display apparatus, characterized in that: the method comprises the following steps:
forming a first alignment film on a first substrate, wherein the first alignment film comprises a liquid solvent;
forming a second alignment film on a second substrate, wherein the second alignment film comprises the liquid solvent;
placing the first substrate and/or the second substrate in a vacuum chamber;
reducing a pressure in the vacuum chamber down to a predetermined vacuum pressure, so as to allow the liquid solvent of the first alignment film and/or the second alignment film in the vacuum chamber to vaporize; and
after the liquid solvent vaporized, forming a liquid crystal layer between the first alignment film and the second alignment film.

7. The method according to claim 6, characterized in that: the pressure in the vacuum chamber is reduced down to a predetermined vacuum pressure, so as to allow the liquid solvent of the film in the vacuum chamber to vaporize.

8. The method according to claim 7, characterized in that: the predetermined vacuum pressure is larger than or equal to 13 Pa and less than or equal to 53 Pa.

9. The method according to claim 8, characterized in that: the predetermined vacuum pressure is larger than or equal to 26 Pa and less than or equal to 53 Pa.

10. The method according to claim 6, characterized in that: a temperature in the vacuum chamber is larger than or equal to 22° C. and less than or equal to 27° C.

11. The method according to claim 6, characterized in that: the method further comprises the following step: after the liquid solvent vaporized for a predetermined time, heating the alignment films under a normal pressure.

12. The method according to claim 11, characterized in that: in the heating process, a temperature for heating is larger than or equal to 80° C. and less than or equal to 100° C.

13. The method according to claim 12, characterized in that: the method further comprises the following step: after heating the alignment films, implementing a high-temperature heating to the alignment films, wherein temperature of the high-temperature heating is larger than or equal to 220° C. and less than or equal to 230° C.

14. A drying method of an alignment film comprising a liquid solvent, characterized in that: the method comprises the following steps:
forming the alignment film on a substrate;
placing the substrate in a vacuum chamber; and
reducing a pressure in the vacuum chamber, so as to allow the liquid solvent of the alignment film in the vacuum chamber to vaporize.

15. The method according to claim 14, characterized in that: the pressure in the vacuum chamber is reduced down to a predetermined vacuum pressure, so as to allow the liquid solvent of the alignment film in the vacuum chamber to vaporize.

16. The method according to claim 15, characterized in that: the predetermined vacuum pressure is larger than or equal to 13 Pa and less than or equal to 53 Pa.

17. The method according to claim 16, characterized in that: the predetermined vacuum pressure is larger than or equal to 26 Pa and less than or equal to 53 Pa.

18. The method according to claim 14, characterized in that: a temperature in the vacuum chamber is larger than or equal to 22° C. and less than or equal to 27° C.

19. The method according to claim 14, characterized in that: the method further comprises the following step: after the liquid solvent vaporized for a predetermined time, heating the alignment film under a normal pressure wherein a temperature for heating is larger than or equal to 80° C. and less than or equal to 100° C.

20. The method according to claim 19, characterized in that: the method further comprises the following step: after heating the alignment films, implementing a high-temperature heating to the alignment films, wherein temperature of the high-temperature heating is larger than or equal to 220° C. and less than or equal to 230° C.
